(19) United States
(12) Patent Application Publication
(10) Pub. No.: US 2012/0303595 A1
(43) Pub. Date: Nov. 29, 2012

(54) DATA RESTORATION METHOD FOR DATA DE-DUPLICATION

(75) Inventors: Wei Liu, Tianjin (CN); Chih-Feng Chen, Taipei (TW)

(73) Assignee: INVENTEC CORPORATION, Taipei (TW)

(21) Appl. No.: 13/240,063

(22) Filed: Sep. 22, 2011

(30) Foreign Application Priority Data
May 25, 2011 (CN) 201110145712.9

(51) Int. Cl. G06F 17/30

(52) U.S. Cl. 707/692; 707/E17.005

(57) ABSTRACT

A data restoration method for data de-duplication uses to restore partial data of a target file of a client, includes the client queries a file attribute of a source file corresponding to the target file from a storage server; the client compares whether the file attribute of the target file is the same as the file attribute of the source file; if the file attributes of the target file and the source file are different, segmentation processing is performed on the target file to generate segmentation data blocks and corresponding fingerprints; after obtaining all the fingerprints of the source file from the storage server, the client compares a difference between the fingerprints of the source file and the target file; the client obtains corresponding segmentation data blocks from the storage server according to the different fingerprints and overwrites the obtained segmentation data blocks to corresponding positions in the target file.

### CROSS-REFERENCE TO RELATED APPLICATIONS

This non-provisional application claims priority under 35 U.S.C. §119(a) on Patent Application No. 201110145712.9 filed in China, P.R.C. on May 25, 2011, the entire contents of which are hereby incorporated by reference.

### BACKGROUND

1. Field of Invention

The present invention relates to a data maintenance method for data de-duplication, and in particular, to a data restoration method for data de-duplication.

2. Related Art

Data de-duplication is a data reduction technology, which is generally used in a backup system based on magnetic disks, and mainly aims at reducing a storage capacity used in a storage system. A working manner of the data de-duplication is searching duplicated variable-size data blocks in different positions of different files within a time cycle. The duplicated data blocks are replaced by indicators. The adoption of the data de-duplication technology may leave more backup space, which not only preserves backup data stored in the storage system for a longer time, but also saves great bandwidth required in offline storage.

During a data de-duplication process, a client 111 performs segmentation processing on an input file 112. After the segmentation processing is performed on the input file 112, multiple data blocks (defined as segmentation data blocks 113 herein) are generated. Referring to FIG. 1, it is a schematic view of segmentation data blocks after data de-duplication according to the prior art. Then, the client 111 performs Hash processing on the segmentation data blocks 113 to generate a fingerprint corresponding to each of the segmentation data blocks 113 (namely fingerprints of the segmentation data blocks 113). The client 111 compares the obtained fingerprints with fingerprints stored in a storage server and judges whether the same fingerprints exist. If the same fingerprints exist, it represents that this data block has been stored in the storage server.

When the client 111 intends to perform data recovery processing, the client 111 sends a file request demand to the storage server. The storage server directly transmits all the segmentation data blocks 113 (namely the entire input file 112) to the client 111 according to the file request demand. The client 111 overwrites the received segmentation data blocks 113 to the input file 112, so as to restore the input file 112. Although such method is quick in speed, for the client 111 (and the storage server), problems such as high load and occupation of the bandwidth in transmission may occur.

### SUMMARY OF THE INVENTION

Accordingly, the present invention is a data restoration method for data de-duplication, which is used to restore partial data of a target file of a client.

The data restoration method for data de-duplication according to the present invention comprises the following steps. The client obtains a file attribute of a target file. The client queries a file attribute of a source file corresponding to the target file from a storage server. The client compares whether the file attribute of the target file is the same as the file attribute of the source file. If the file attributes of the target file and the source file are different, segmentation processing is performed on the target file to generate at least one segmentation data block and a corresponding fingerprint. After obtaining all the fingerprints of the source file from the storage server, the client compares a difference between the fingerprints of the source file and the target file. The client obtains the corresponding segmentation data blocks from the storage server according to the different fingerprints, and overwrites the obtained segmentation data blocks to corresponding positions in the target file.

Accordingly, the present invention is a data restoration method for data de-duplication, which is used to restore partial data of a target file of a client. The client restores partial data of the target file through fingerprints stored by a storage server and corresponding segmentation data blocks.

### BRIEF DESCRIPTION OF THE DRAWINGS

FIG. 1 is a schematic view of segmentation data blocks after data de-duplication according to the prior art;

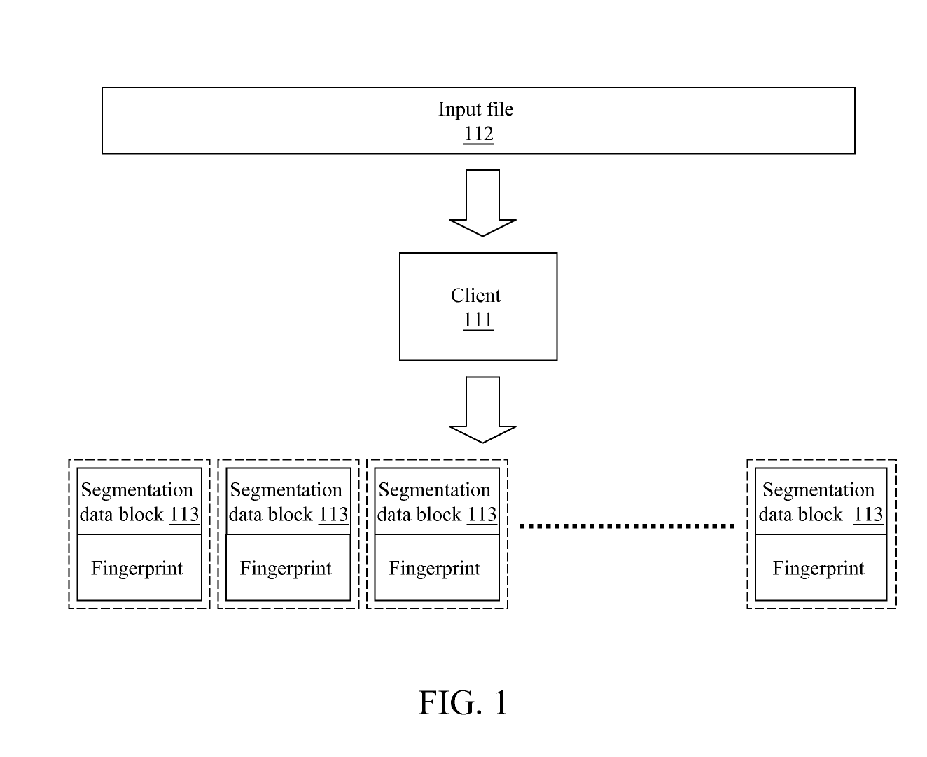

FIG. 2 is a schematic architectural view of the present invention;

FIG. 3 is a schematic flow chart of data de-duplication according to the present invention;

FIG. 4 is a schematic architectural view of an operation process according to the present invention; and

FIG. 5 is a schematic view of a difference of segmentation data blocks according to the present invention.

### DETAILED DESCRIPTION OF THE INVENTION

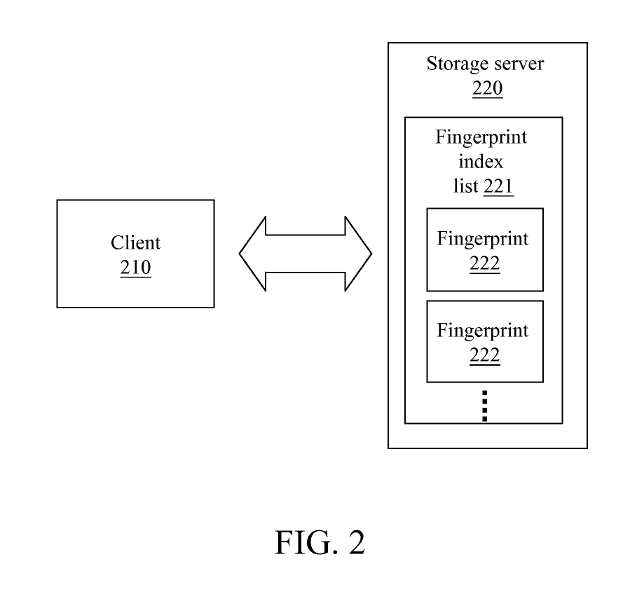

Referring to FIG. 2, it is a schematic architectural view of the present invention. Referring to FIG. 2, it is a schematic architectural view of the present invention. The present invention comprises a client 210 and a storage server 220. The client 210 may be connected to the storage server 220 through Internet or enterprise Intranet. The client 210 and the storage server 220 may also run simultaneously on a same computer device.

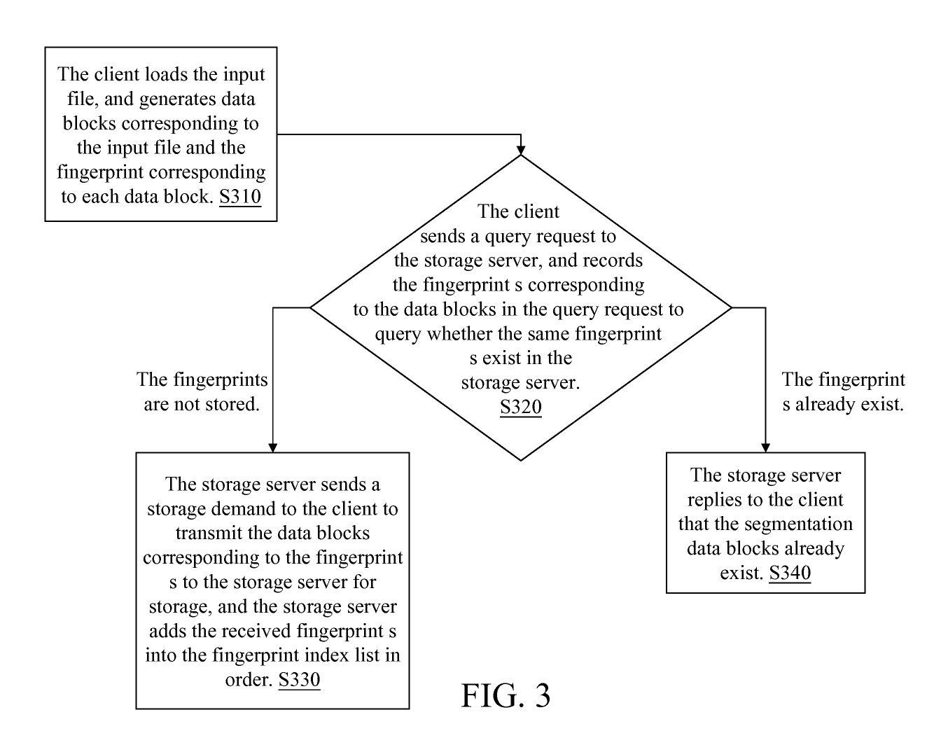

The storage server 220 further comprises a fingerprint index list 221, and the fingerprint index list records multiple groups of fingerprints 222. When the client 210 sends a demand for querying an input file to the storage server 220, the storage server 220 performs a query action according to content recorded in the fingerprint index list 221 through following manners. Referring to FIG. 3, it is a schematic flow chart of data de-duplication according to the present invention.

In Step S310, the client loads the input file, and generates data blocks corresponding to the input file and the fingerprint corresponding to each data block.

In Step S320, the client sends a query request to the storage server, and records the fingerprints corresponding to the data blocks in the query request to query whether the same fingerprints exist in the storage server.

In Step S330, when the fingerprint index list of the storage server does not store the fingerprints, the storage server sends a storage demand to the client to transmit the data blocks corresponding to the fingerprints to the storage server for storage, and the storage server adds the received fingerprints into the fingerprint index list in order.

In Step S340, when the fingerprints already exist in the fingerprint index list of the storage server, the storage server replies to the client that the segmentation data blocks already exist.

The client 210 loads the input file. The client 210 performs segmentation processing on the input file and generates the data blocks corresponding to the input file and the fingerprint 222 corresponding to each data block. An algorithm for calculating the fingerprints 222 may be, but is not limited to, SHA-1 or MD5. The data blocks are obtained according to a fixed-size partition manner or based on a content-defined chunking (CDC) manner. A fixed-size partition algorithm segments the input file by using a predefined size of a segmentation data block. The advantage of the fixed-size algorithm lies in simplicity and high performance. A CDC algorithm is a variable-size block algorithm, and adopts a strategy of segmenting a file into blocks of different sizes using fingerprint data (such as Rabin fingerprint). Unlike the fixed-size segmentation algorithm, the CDC algorithm performs segmentation based on the content of the input file, and therefore, the size of the segmentation data block is variable.

Then, the client 210 sends the query request to the storage server 220, and records the fingerprints 222 corresponding to the data blocks in the query request, so as to query whether the same fingerprints 222 exist in the storage server 220. When the fingerprint index list 221 of the storage server 220 does not store the fingerprints 222, the storage server 220 sends the storage demand to the client 210 to transmit the data blocks corresponding to the fingerprints 222 to the storage server 220 for storage, and the storage server 220 adds the received fingerprints 222 into the fingerprint index list 221 in order.

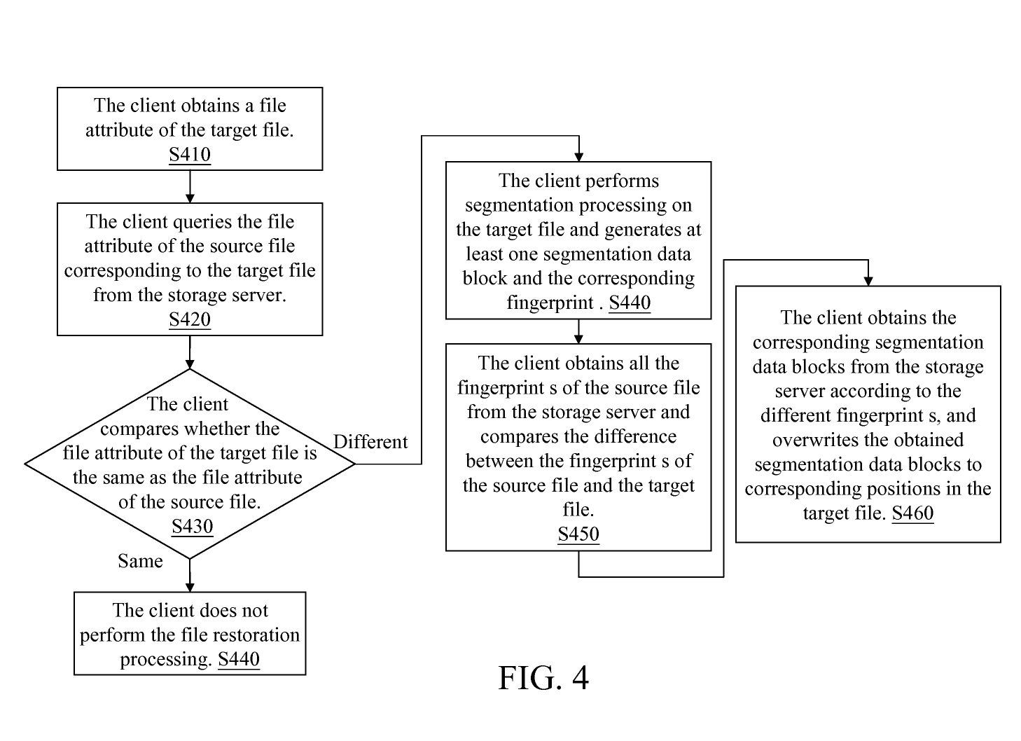

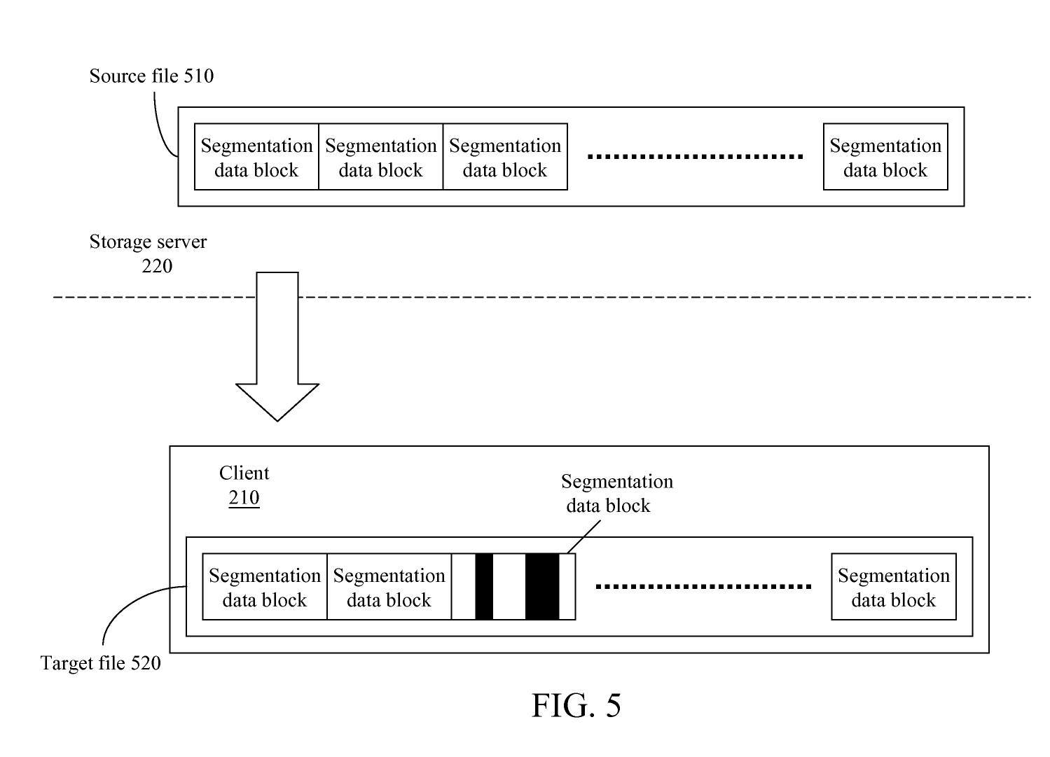

When the client 210 intends to perform restoration processing on the file, the client 210 sends a file restoration demand to the storage server 220. In order to clarify the file of the client 210 and the file stored in the server, the file that the client 210 intends to restore is defined as a target file. A data file (namely the segmentation data blocks of each file) stored in the storage server 220 is defined as a source file, and therefore, the number of the source file is greater than one. The storage server 220 performs the corresponding file restoration processing according to following steps. Referring to FIG. 4 and FIG. 5, FIG. 4 and FIG. 5 are respectively a schematic view of an operation process and a schematic view of a difference of segmentation data blocks according to the present invention. The process comprises the following steps.

In Step S410, the client obtains a file attribute of the target file.

In Step S420, the client queries the file attribute of the source file corresponding to the target file from the storage server.

In Step S430, the client compares whether the file attribute of the target file is the same as the file attribute of the source file.

In Step S440, if the file attributes of the target file and the source file are the same, the client does not perform the file restoration processing.

In Step S450, if the file attributes of the target file and the source file are different, the client performs segmentation processing on the target file and generates at least one segmentation data block and the corresponding fingerprint.

In Step S460, the client obtains all the fingerprints of the source file from the storage server and compares the difference between the fingerprints of the source file and the target file.

In Step S470, the client obtains the corresponding segmentation data blocks from the storage server according to the different fingerprints, and overwrites the obtained segmentation data blocks to corresponding positions in the target file.

First, the client 210 obtains the file attribute of the target file, and the file attribute is a Time Stamp or an Index. In other words, before the client 210 performs the segmentation processing on the target file, the client 210 records the file attribute of the target file 520. Then, the client 210 queries the file attribute of the source file 510 corresponding to the target file 520 from the storage server 220. The storage server 220 searches whether the file attribute of the source file 510 corresponding to the target file 520 is already stored. If the client 210 has backed up data for the target file 520 before, the storage server 220 stores the source file 510 corresponding to the target file 520 and the related file attribute.

The client 210 compares the file attribute of the source file 510 transmitted from the storage server 220 with the file attribute of the target file 520. If the file attribute is, for example, the Time Stamp, different Time Stamps are given to data files created at different times. Therefore, when the file attributes of the target file 520 and the source file 510 are different, it represents that the target file 520 is modified.

If the file attributes of the target file 520 and the source file 510 are different, the client 210 performs segmentation processing on the target file 520 and generates at least one segmentation data block and the corresponding fingerprint 222. The client 210 obtains all the fingerprints 222 of the source file 510 from the storage server 220. The client 210 compares the difference between the fingerprints 222 of the source file 510 and the target file 520 (namely black blocks of the segmentation data block in FIG. 5).

After receiving the demand for requesting the fingerprints 222 from the client 210, the storage server 220 may transmit the fingerprints 222 in one batch or in different batches to the client 210. Since a data volume of the fingerprints 222 is much smaller than that of the segmentation data blocks, the transmission process of the fingerprints 222 does not seriously affect the use of the bandwidth. Finally, the client 210 obtains the corresponding segmentation data blocks from the storage server 220 according to the different fingerprints 222, and overwrites the obtained segmentation data blocks to the corresponding positions in the target file 520.

The present invention provides a data restoration method for data de-duplication, which is used to restore partial data of the target file 520 of the client 210. The client 210 restores partial data of the target file 520 through the fingerprints 222 stored in the storage server 220 and the corresponding segmentation data blocks. Moreover, compared with the conventional technology, the present invention does not need one-by-one reading and writing for the target file 520, but only needs processing of reading and calculation. Compared with the conventional technology, the present invention has effectively reduced time for writing.

What is claimed is:

1. A data restoration method for data de-duplication, capable of restoring partial data of a target file of a client according to a source file after data de-duplication processing stored in a storage server, comprising:
the client obtaining a file attribute of the target file;
the client querying a file attribute of a source file corresponding to the target file from the storage server;
the client comparing whether the file attribute of the target file is the same as the file attribute of the source file;
performing segmentation processing on the target file and generating at least one segmentation data block and a corresponding fingerprint if the file attributes of the target file and the source file are different;
after obtaining all the fingerprints of the source file from the storage server, the client comparing a difference between the fingerprints of the source file and the target file; and
the client obtaining the corresponding segmentation data blocks from the storage server according to the different fingerprints, and overwriting the obtained segmentation data blocks to corresponding positions in the target file.

2. The data restoration method for the data de-duplication according to claim 1, wherein the file attribute is a Time Stamp or an Index.

3. The data restoration method for the data de-duplication according to claim 1, wherein the fingerprint is generated through a Hash algorithm or a One Way algorithm.

4. The data restoration method for the data de-duplication according to claim 1, wherein the step of overwriting the obtained segmentation data blocks to the corresponding positions in the target file further comprises:
the client repeatedly comparing the different fingerprints and obtaining the corresponding segmentation data blocks from the storage server, and performing the overwriting on the target file until the target file is entirely completed.
